(19) United States
(12) Patent Application Publication
(10) Pub. No.: US 2022/0276454 A1
(43) Pub. Date: Sep. 1, 2022

(54) OPTICAL RECEIVING ENGINE BASED ON PLANAR WAVEGUIDE CHIP

(71) Applicant: IRIXI PHOTONICS (SUZHOU) CO., LTD., Suzhou (CN)

(72) Inventors: Yifan CHEN, Suzhou (CN); Rui ZHENG, Suzhou (CN)

(21) Appl. No.: 17/632,655

(22) PCT Filed: Nov. 18, 2019
(86) PCT No.: PCT/CN2019/119106

§ 371 Date: Feb. 3, 2022

(30) Foreign Application Priority Data
Aug. 29, 2019 (CN) 201910805981.X

(51) Int. Cl. G02B 6/42

(52) U.S. Cl. CPC G02B 6/4286; G02B 6/4287

(57) ABSTRACT

An optical receiving engine based on planar waveguide chip includes an arrayed waveguide chip used for receiving an optical signal sent by an optical fiber, an output waveguide of the arrayed waveguide chip with a multi-mode waveguide structure, the light is incident to the arrayed waveguide chip and then being output through the output waveguide, and the light having different wavelengths corresponding to different mode field distributions of the output waveguide; a detector coupled with the arrayed waveguide chip, a photosensitive area of the detector being determined based on a mode field distribution range of the output waveguide; and an amplifier connected to the detector. The shortcoming in the prior art of low coupling efficiency can be solved. Optimizing the photosensitive area of the detector can enable the photosensitive area to match a spot mode field of the waveguide chip, thereby improving the coupling efficiency.

### CROSS REFERENCE TO RELATED APPLICATIONS

This application claims priority of Chinese Patent Application No. 201910805981.X, filed Aug. 29, 2019, the entire disclosures of both of which are incorporated herein by reference.

### FIELD OF THE INVENTION

This application relates to an optical receiving engine based on planar waveguide chip, which belongs to the technical field of optical communications.

### DESCRIPTION OF THE PRIOR ART

With the advent of 5G era, the demand for data transmission shows explosive growth, and the technology of optical fiber communication has always been concerned with the high bandwidth characteristics. Optical transceiver is an important part of the overall optical communication link, which needs to realize the conversion of photoelectric signals.

Since WDM (wavelength division multiplexing) structures can effectively take advantage of the high bandwidth of the optical fiber, WDM devices can be used to couple multiple optical signals with different wavelengths to a single optical fiber. In order to realize the coupling and decoupling function of light in optical fiber with wavelength division multiplexing structure, arrayed waveguide chip is usually used to split the light in optical fiber.

The arrayed waveguide chip needs to have the characteristic of wavelength insensitive at the light-receiving end, i.e., the flat-top transmission spectrum. Usually, the flat-top transmission spectrum is realized by making the output waveguide of the arrayed waveguide chip into a multi-mode waveguide structure. At this point, when the wavelength changes, the mode field distribution of the output waveguide of the arrayed waveguide chip changes accordingly.

However, the arrayed waveguide chip with multi-mode waveguide structure are unable to maintain the single-mode field at the output end of the chip, which makes the coupling between arrayed waveguide chip and detector difficult, and the coupling efficiency is low.

### BRIEF SUMMARY OF THE INVENTION

An exemplary embodiment of the disclosure aims to provide an optical receiving engine based on planar waveguide chip, which can solve the problem of low coupling efficiency between arrayed waveguide chip and the detector. The present invention is realized as the follow technical solution:

An optical receiving engine based on planar waveguide chip, which includes:

an arrayed waveguide chip used for receiving an optical signal sent by an optical fiber, an output waveguide of the arrayed waveguide chip with a multi-mode waveguide structure, the light is incident to the arrayed waveguide chip and then being output through the output waveguide, and the light having different wavelengths corresponding to different mode field distributions of the output waveguide;

a detector coupled with the arrayed waveguide chip, a photosensitive area of the detector being determined based on a mode field distribution range of the output waveguide;

and an amplifier connected to the detector.

Optionally, the normal direction of the light-emitting surface of the arrayed waveguide chip points to the photosensitive area of the detector.

Optionally, a total reflection surface is formed in the arrayed waveguide chip, the total reflection surface is used to fully reflect the light transmitted in the arrayed waveguide chip to the upper surface of the arrayed waveguide chip and emit the light; the center of the photosensitive area of the detector coincides with the center of the output optical field of the upper surface.

Optionally, the arrayed waveguide chip is supported by a support, so as to provide a preset distance between the detector and the area on the upper surface of the arrayed waveguide chip for emitting light.

Optionally, the photosensitive area of the detector comprises the mode field distribution range of the output waveguide, and the size of the photosensitive area is less than or equal to the size threshold.

Optionally, shape of the mode field distribution range is rectangular, correspondingly, the photosensitive area of the detector is rectangular, and the ratio of width to height of the rectangle of the photosensitive area is equal to the ratio of width to height of the rectangle of the mode field distribution range.

Optionally, the shape of the mode field distribution range is oval, correspondingly, the photosensitive area of the detector is rectangular, and the ratio of width to height of the rectangle of the photosensitive area is equal to the ratio of width to height of the rectangle of the mode field distribution range.

Optionally, the detector bonds to the amplifier through gold wires.

Optionally, the arrayed waveguide chip comprises a core layer and a cladding layer wrapped around the core layer, and the ratio of the width to the height of the core layer is [3, 5]; the range of the difference between the refractive index of the core layer and the refractive index of the cladding layer is [0.75%, 2.5%].

Optionally, the amplifier is a transimpedance amplifier.

The beneficial effect of the present invention is:

By disposing an arrayed waveguide chip of which the output waveguide gets multi-mode waveguide structure, the light is incident into the arrayed waveguide chip and emits through the output waveguide, and the mode field distribution of the output waveguide is different for different wavelengths of light. By disposing a detector coupled with the arrayed waveguide chip, the photosensitive area of the detector is determined based on the mode field distribution range of the output waveguide. And, by disposing an amplifier connected to the detector, the problem in the prior art of low coupling efficiency between an array waveguide chip and a detector can be solved. Optimizing the photosensitive area of the detector can enable the photosensitive area to match a spot mode field of the waveguide chip, thereby improving the coupling efficiency.

The above description is only an outline of the technical schemes of the present invention. Preferred embodiments of the present invention are provided below in conjunction with the attached drawings to enable one with ordinary skill in the art to better understand said and other objectives, features, and advantages of the present invention and to make the present invention accordingly.

### BRIEF DESCRIPTION OF THE DRAWINGS

FIG. 1 and FIG. 2 are structural diagrams depicting the optical receiving engine based on planar waveguide chip in one embodiment of the present invention.

FIG. 3 is a diagram depicting the section of the arrayed waveguide chip in one embodiment of the present invention.

FIG. 4 is a diagram depicting the photosensitive area of the detector in one embodiment of the present invention.

FIG. 5 is a diagram depicting the photosensitive area of the detector in another embodiment of the present invention.

### DETAILED DESCRIPTION OF THE PREFERRED EMBODIMENTS

Specific embodiments of the present invention are described in further detail in combination with the related drawings and embodiments below. However, in addition to the descriptions given below, the present invention can be applied to other embodiments, and the scope of the present invention is not limited by such, rather by the scope of the claims.

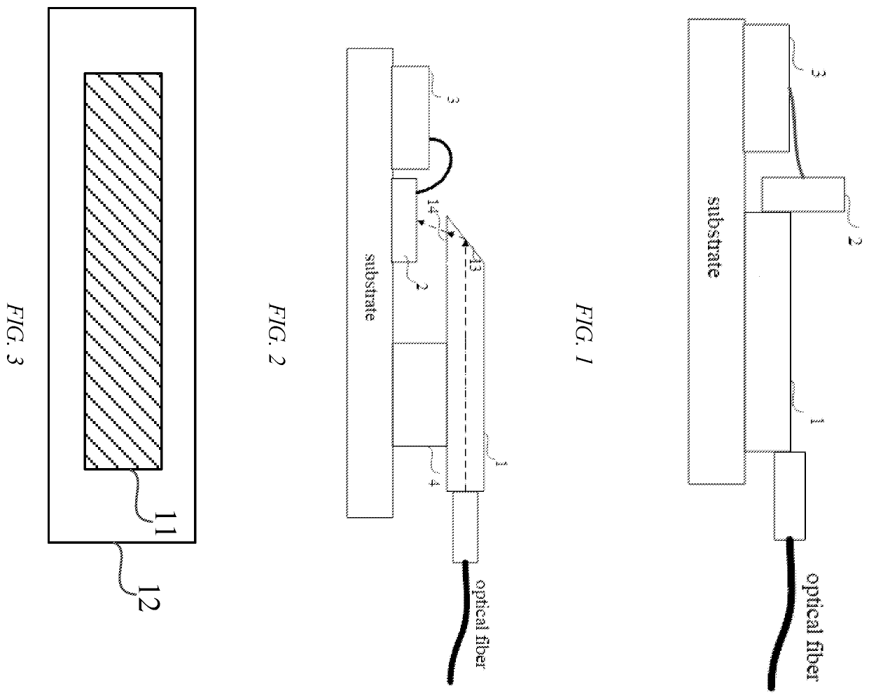

FIG. 1 and FIG. 2 are structural diagrams depicting the optical receiving engine based on planar waveguide chip in one embodiment of the present invention, as shown in the diagrams, the optical receiving engine includes at least:

an arrayed waveguide chip (1) used for receiving an optical signal sent by an optical fiber, an output waveguide of the arrayed waveguide chip (1) with a multi-mode waveguide structure, the light is incident to the arrayed waveguide chip and then being output through the output waveguide, and the light having different wavelengths corresponding to different mode field distributions of the output waveguide

a detector (2) coupled with the arrayed waveguide chip (1), a photosensitive area of the detector (2) being determined based on a mode field distribution range of the output waveguide;

and an amplifier (3) connected to the detector (2).

Optionally, the photosensitive area of the detector (2) is determined based on the variation range of the peak position in the mode field distribution of the output waveguide.

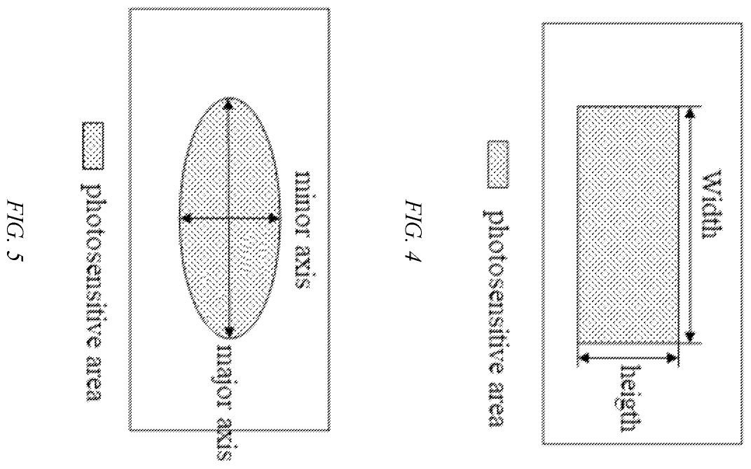

Refer to the section diagram of the arrayed waveguide chip (1) shown in FIG. 3, the arrayed waveguide chip (1) comprises a core layer (11) and a cladding layer (12) wrapped around the core layer (11). Optionally, in order to guarantee the quality and efficiency of the optical transmission of the arrayed waveguide chip (1), the core layer (11) is designed as a rectangular with the ratio of the width to the height is [3, 5]; and the range of the difference between the refractive index of the core layer (11) and the refractive index of the cladding layer (12) is [0.75%, 2.5%].

Optionally, the arrayed waveguide chip (1) can be coupled to the detector (2) in the following ways:

The first one (refer to FIG. 1): the normal direction of the light-emitting surface of the arrayed waveguide chip (1) points to the photosensitive area of the detector (2). Optionally, the detector (2) is directly fixed on the light-emitting surface of the arrayed waveguide chip (1); alternatively, there is air between the detector (2) and the light-emitting surface of the arrayed waveguide chip (1).

The second one (refer to FIG. 2): the arrayed waveguide chip (1) forms a total reflection surface (13), the total reflection surface (13) is used to fully reflect the light transmitted in the arrayed waveguide chip to the upper surface (14) of the arrayed waveguide chip and emit the light; the center of the photosensitive area of the detector (2) coincides with the center of the output optical field of the upper surface (14). Refer to FIG. 2, the optical signal (represented by the dotted arrow) inside the arrayed waveguide chip (1) emits from the upper surface (14) after passing through the total reflective surface (13) of the arrayed waveguide chip (1), and then points to the center of the photosensitive area of the detector (2) after refracting between the arrayed waveguide chip (1) and the air layer interface.

Optionally, since there are edges and corners in the total reflection surface (13), in order to prevent damage caused by collision with the total reflection surface (13) when the detector (2) is directly installed on the upper surface (14). In this embodiment, the arrayed waveguide chip (1) is propped by strutting piece (4), so as to separate the detector (2) from the area of the upper surface (14) of the arrayed waveguide chip (1) for emitting light by a present distance.

Where, the total reflection surface (13) can be formed by polishing the end face of the arrayed waveguide chip (1); alternatively, by setting a reflector on the end face of the arrayed waveguide chip (1). The setting method of the total reflection surface (13) is not limited in this embodiment.

Optionally, the detector (2) can be connected to the amplifier (3) by gold wire bonding.

Optionally, the amplifier (3) can be a trans-impedance amplifier (TIA), or any other types of amplifier, which is not limited in this embodiment.

In this embodiment, the photosensitive area of the detector (2) is determined based on the mode field distribution range of the output waveguide in the following ways: the photosensitive area of the detector (2) includes the mode field distribution range, and the size of the photosensitive area is less than or equal to the size threshold.

Optionally, the size of the photosensitive area of the detector (2) is greater than or equal to the mode field distribution range of the output waveguide.

Where, the size threshold is determined according to the maximum detection bandwidth of the detector (2). Since the maximum detection bandwidth of the detector (2) is fixed, and the lager the photosensitive area of the detector (2), the smaller the corresponding bandwidth is. Therefore, in this embodiment, in order to ensure requirement of the maximum detection bandwidth of the detector (2), the size of the photosensitive area is less than or equal to the size threshold.

Optionally, refer to FIG. 4, the shape of the mode field distribution range of the output waveguide is rectangular, correspondingly, the photosensitive area of the detector is rectangular, and the ratio of the width to the height of the photosensitive area is equal to the ratio of the width to the height of the mode field distribution range. For example: if the ratio of width to height of the mode field distribution range is 2:1, the ratio of width to height of the photosensitive area is also 2:1. At this point, the photosensitive area of the detector (2) can detect the mode field distribution of the output waveguide corresponding to each wavelength.

Alternatively, refer to FIG. 5, the shape of the mode field distribution range is elliptical, correspondingly, the photosensitive area of the detector is elliptical, and the ratio of the major axis to the minor axis of the photosensitive area is equal to the ratio of the major axis to the minor axis of the mode field distribution range. For example, if the ratio of the major axis to the minor axis of the photosensitive area is 2:1, the ratio of the major axis to the minor axis of the mode field distribution range is also 2:1. At this point, the photosensitive area of the detector (2) can detect the mode field distribution of the output waveguide corresponding to each wavelength.

In this embodiment, the size of the photosensitive area of the detector (2) is determined based on the size of the mode field distribution range of the output waveguide. And the size of the photosensitive area of the detector (2) does not need to be fixed as the size threshold, which can not only ensure the detection accuracy, but also reduce the area of the photosensitive area of the detector (2) and increase the maximum detection bandwidth of the detector (2) in some scenes.

Certainly, the optical receiving engine based on the planar waveguide chip provided in this embodiment can also have other components, such as substrates with electrical function and mechanical support function, which will not be listed in this embodiment one by one.

To sum up, the optical receiving engine based on planar waveguide chip in this embodiment dispose an arrayed waveguide chip of which the output waveguide gets multi-mode waveguide structure, the light is incident into the arrayed waveguide chip and emits through the output waveguide, and the mode field distribution of the output waveguide is different for different wavelengths of light. By disposing a detector coupled with the arrayed waveguide chip, the photosensitive area of the detector is determined based on the mode field distribution range of the output waveguide. And, by disposing an amplifier connected to the detector, the problem in the prior art of low coupling efficiency between an array waveguide chip and a detector can be solved. Optimizing the photosensitive area of the detector can enable the photosensitive area to match a spot mode field of the waveguide chip, thereby improving the coupling efficiency.

In addition, in this embodiment, the photosensitive area of the detector includes the mode field distribution range of the output waveguide, and the size of the photosensitive area is less than or equal to the size threshold, which can not only reduce the junction capacitance of the detector, but also enhance the matching degree with the mode field of the arrayed waveguide chip and improve the coupling efficiency, so as to increase the coupling tolerance and realize the installation without accurate alignment and reduce installation difficulty.

The technical features of the above embodiments can be combined arbitrarily, in order to make the description concise, not all possible combinations of the technical features in the above embodiments are described. However, as long as there is no contradiction between the combination of these technical features, they shall be considered to be within the scope of this description.

The present invention only described several above embodiments, which are described more specific and detailed, but it cannot be understood as a limitation on the scope of the present invention. It should be pointed out that for ordinary technical personnel in the art, without departing from the concept of the present invention, a number of deformation and improvements can be made, which belong to the scope of the present invention. Therefore, the scope of the present invention shall be subject to the recorded claims.

1. An optical receiving engine based on planar waveguide chip, characterized in that the optical receiving engine including:
an arrayed waveguide chip used for receiving an optical signal sent by an optical fiber, an output waveguide of the arrayed waveguide chip with a multi-mode waveguide structure, the light is incident to the arrayed waveguide chip and then being output through the output waveguide, and the light having different wavelengths corresponding to different mode field distributions of the output waveguide;
a detector coupled with the arrayed waveguide chip, a photosensitive area of the detector being determined based on a mode field distribution range of the output waveguide;
and an amplifier connected to the detector.

2. The optical receiving engine according to claim 1, characterized in that the normal direction of the light-emitting surface of the arrayed waveguide chip points to the photosensitive area of the detector.

3. The optical receiving engine according to claim 1, characterized in that a total reflection surface is formed in the arrayed waveguide chip, the total reflection surface is used to fully reflect the light transmitted in the arrayed waveguide chip to the upper surface of the arrayed waveguide chip and emit the light; the center of the photosensitive area of the detector coincides with the center of the output optical field of the upper surface.

4. The optical receiving engine according to claim 3, characterized in that the arrayed waveguide chip is supported by a support, so as to provide a preset distance between the detector and the area on the upper surface of the arrayed waveguide chip for emitting light.

5. The optical receiving engine according to claim 1, characterized in that the photosensitive area of the detector comprises the mode field distribution range of the output waveguide, and the size of the photosensitive area is less than or equal to the size threshold.

6. The optical receiving engine according to claim 5, characterized in that the shape of the mode field distribution range is rectangular, correspondingly, the photosensitive area of the detector is rectangular, and the ratio of width to height of the rectangle of the photosensitive area is equal to the ratio of width to height of the rectangle of the mode field distribution range.

7. The optical receiving engine according to claim 5, characterized in that the shape of the mode field distribution range is oval, correspondingly, the photosensitive area of the detector is rectangular, and the ratio of width to height of the rectangle of the photosensitive area is equal to the ratio of width to height of the rectangle of the mode field distribution range.

8. The optical receiving engine according to claim 1, characterized in that the detector bonds to the amplifier through gold wires.

9. The optical receiving engine according to claim 1, characterized in that the arrayed waveguide chip comprises a core layer and a cladding layer wrapped around the core layer, and the ratio of the width to the height of the core layer is [3, 5]; the range of the difference between the refractive index of the core layer and the refractive index of the cladding layer is [0.75%, 2.5%].

10. The optical receiving engine according to claim 1, characterized in that the amplifier is a transimpedance amplifier.
